(19) United States
(12) Patent Application Publication
(10) Pub. No.: US 2018/0048749 A1
(43) Pub. Date: Feb. 15, 2018

(54) SYSTEM PROVIDING BUSINESS DIRECTORY SERVICE FOR VOICE ACTIVATED MESSAGING

(71) Applicant: RADHAKRISHNA HIREMANE, BEAVERTON, OR (US)

(72) Inventor: RADHAKRISHNA HIREMANE, BEAVERTON, OR (US)

(21) Appl. No.: 15/377,909

(22) Filed: Dec. 13, 2016

Related U.S. Application Data
(60) Provisional application No. 62/373,233, filed on Aug. 10, 2016.

(51) Int. Cl. H04M 1/27; H04M 1/725; H04M 3/53; H04M 3/533

(52) U.S. Cl. CPC H04M 1/271; H04M 3/53366; H04M 1/72552; H04M 3/5322; H04M 2201/60

(57) ABSTRACT

A system and method of providing a voice activated message service to a business is disclosed. Embodiments use a computing device enabled with voice recognition to look up a business name and location from a database in response to a user's voice activated command and message. The system may automatically send the message to the business without divulging the business side contact information. A reply from the business may be provided to the user through the system or directly still without divulging the business side contact information.

### CROSS-REFERENCE TO RELATED APPLICATIONS

This application claims benefit under 35 U.S.C. § 119(e) of U.S. Provisional Application having Ser. No. 62/373,233 filed Aug. 10, 2016, which is hereby incorporated by reference herein in its entirety.

### BACKGROUND

The embodiments herein relate generally to network communications and mare particularly, to systems of electronic communication between a consumer and a business.

Voice recognition and voice activated devices allow users to speak a task into an electronic computing device and expect a voice based response by the device. For example, instant messages or e-mails may use dictation software to initiate a message function and record the message to be sent through the message function. Typically the voice activated message function is directed to a stored contact in the device. The application does not function unless the user pre-stores the contact's information including phone number. Without the contact information of the receiving person on the device the messages cannot be delivered.

Previously the sender of the message was required to store the mobile number or contact information of a business to send a message or chat with that business.

As can be seen there is a need for a voice based messaging system which enables consumers to send communicate with businesses without exposing private phone information related to the business representative.

### SUMMARY

In one aspect, a computer program product for a voice activated message to a business, comprises a non-transitory computer readable storage medium having computer readable program code embodied therewith. The computer readable program code is configured to: recognize a user's voice activated command and voice based message from a computing device running a software application of the computer program product; search, via a request made from the computing device through a telecommunications network, an electronic database for a business targeted by the voice based message; retrieve contact information for the targeted business; and send contents of the voice based message to a contact matching the contact information through a messaging service.

In another aspect, a method of providing a voice activated message to a business comprises: recognizing a user's voice activated command and voice based message from a computing device running a software application of the computer program product; searching, via a request made from the computing device through a telecommunications network, an electronic database for a business targeted by the voice based message; retrieving contact information for the targeted business; and sending contents of the voice based message to a contact matching the contact information through a messaging service.

### BRIEF DESCRIPTION OF THE FIGURES

The detailed description of some embodiments of the invention is made below with reference to the accompanying figures, wherein like numerals represent corresponding parts of the figures.

FIG. 1 is a block diagram showing a series of actions in a system for providing a service using voice activated messaging according to embodiments of the subject technology.

FIG. 2 is a flowchart of a method for providing voice activated messaging to a business according to an embodiment of the subject technology.

FIG. 3 is a block diagram of a computer system/server according to an embodiment of the subject technology.

### DETAILED DESCRIPTION OF CERTAIN EMBODIMENTS

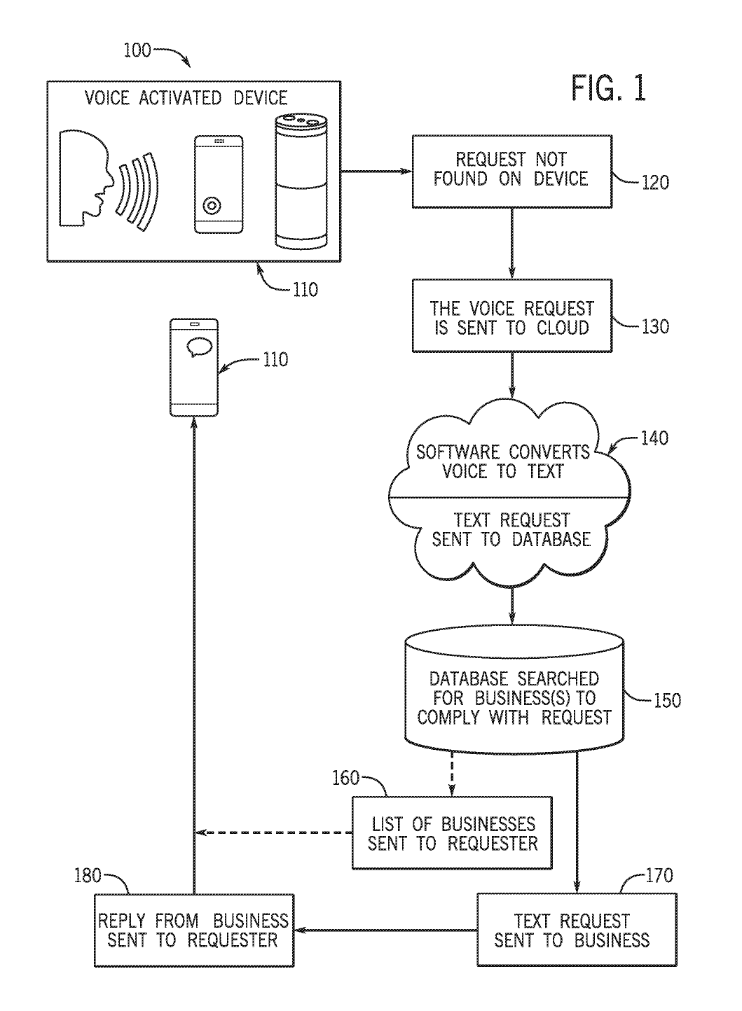

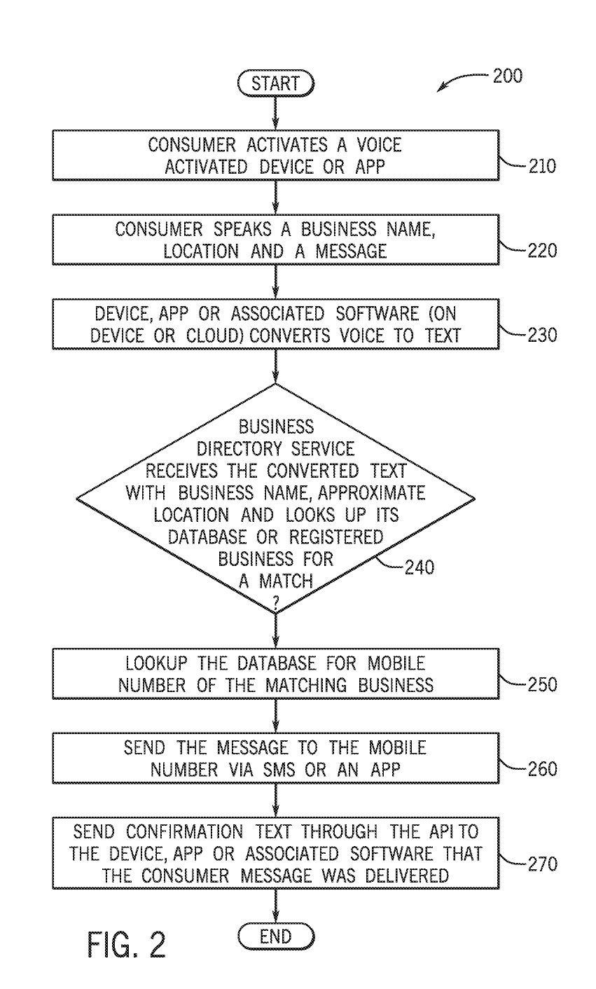

In general and referring to FIGS. 1-2, embodiments of the disclosed subject technology provide a voice activated messaging system from a user's electronic computing device that contacts a business through an electronic business directory. The message sender only needs to know the name and approximate location of the business, and does not need to know or store the mobile number to contact. Business directory services can map the appropriate business name to the mobile device destination and deliver the message to the business mobile device.

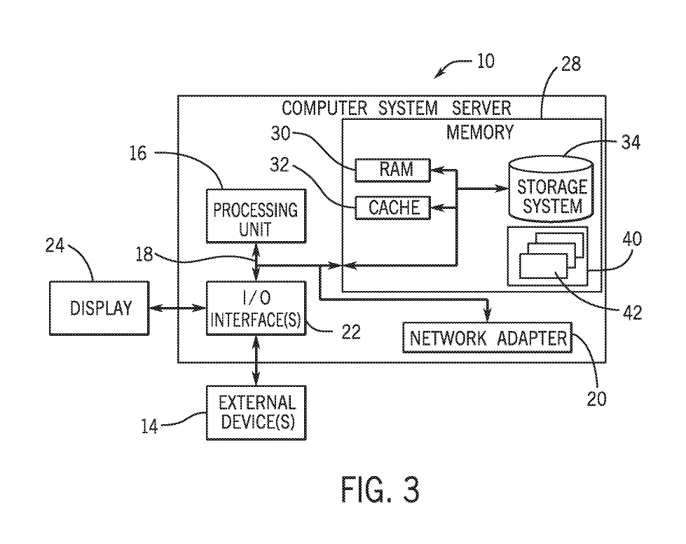

FIG. 1 shows a system 100 that may include a voice activated computing device 110 that is configured to communicate with a remote server 140. Actions between the device 110 and the server 140 are shown in text box form, which represent the content of signals sent between the device 10 and the server 140. FIG. 2 shows a flowchart of a process 200 for providing voice activated messaging to a business. In some instances, the interaction between the device 110 and the server 140 may overlap the steps in the flowchart 200, which will be noted in the description that follows. In operation, the user may activate 210 a software embodiment that includes voice recognition functionality. A computing device 110 (described more fully below with respect to FIG. 3, but as shown may be for example a mobile smart phone or a programmable consumer device) may recognize the voice activated command and may request or automatically receive input from the user.

In an exemplary embodiment, the user speaks 220 a command that includes information directed to a business by name and location, and in some instances is accompanied by additional information the user wishes to be forwarded to the business. The user need not know the business' contact number as the system locates the number for the user. As will be appreciated, the user can thus contact a business (one of its representatives directly) without having to pre-store the business contact information in for example, the user's mobile smart phone or other computing device's contact list. In comparison, prior art systems require one to have contact information stored on a device when using a voice activated command to contact the business. Since a business will not generally list more than one general contact number, the user is typically subject to an automated telephone transfer system before being put in touch with a representative. As will be further appreciated, aspects of the system allow the business to list contact numbers for representatives anonymously so that when the user makes a general inquiry, any one of, or a best suited representative will receive the user's message without revealing the contact number.

If the device 110 does not recognize 120 the message request from the user's speech, the request may be sent 130 to the server 140. In some embodiments the server 140 may be cloud based. A voice recognition function may convert 230 the content of the voice command into text to recognize for example, a request for contact with the named business. Voice recognition and conversion to text may be performed at the device 110 or at the server 140. The name of the business and location may be extracted from the voice command content and forwarded 240 to a database 150. The database 150 may store data related to businesses by name, contact information (including contact numbers), and approximate location. The converted text is used to search the database 150 to match the requested business with stored records. Contact information for the matched business may be accessed 250 by the system 100 and the user's message may be sent 170 to a contact number for the business through SMS or another electronic messaging system. A reply from the matched business may be sent 180 to the user in response to the voice activated command and request. In some embodiments, the reply can be sent to the voice activated computing device 110 and a response is stored like an answering machine. The business response can be held in the cloud in text, and played back in voice on the device 110. As may be appreciated, the business number does not have to be revealed by this approach. In another embodiment, the reply can be sent through a custom chat application to the user's account, which does not reveal the business mobile number in the reply. Another approach may use a programmable SMS service to send the reply which hides the business mobile number. In the event an exact match is not found in the database 150, a list of businesses that are closest to matching may be sent 160 to the user's device 110. The user may then repeat the voice activated request process with a selected business from the list provided.

As will be appreciated, a business may have representatives available to receive voice based messages to for example, smart phones or other computing devices without having to reveal the numbers for those devices. Thus users are provided with convenient means to communicate with a business without having to perform undue searching for contact information and also avoid having to engage with systems that use a menu of selections to speak to a representative.

Referring now to FIG. 3, a schematic of an example of a computer system/server 10 is shown. The computer system/server 10 is shown in the form of a general-purpose computing device. The computer system/server 10 may represent either the voice activated computing device 110 or the server 140. The components of the computer system/server 10 may include, but are not limited to, one or more processors or processing units 16, a system memory 28, and a bus 18 that couples various system components including the system memory 28 to the processor 16. The computer system/server 10 may be for example, mobile telephone devices, tablet devices, handheld or laptop devices, programmable computing consumer devices (for example home based voice activated wireless speaker hubs) or wearable devices when embodiments are provided as an application being interfaced by users. The computer system/server 10 may be, when serving a role as an intermediary node between users or as a software as a service provider, a server computer system, multiprocessor systems, microprocessor-based systems, network PCs, and distributed cloud computing environments that include any of the above systems or devices, and the like. The computer system/server 10 may be described in the general context of computer system executable instructions, such as program modules, being executed by a computer system (described for example, below). The computer system/server 10 may be practiced in distributed cloud computing environments where tasks are performed by remote processing devices that are linked through a communications network. In a distributed cloud computing environment, program modules may be located in both local and remote computer system storage media including memory storage devices.

The computer system/server 10 may typically include a variety of computer system readable media. Such media could be chosen from any available media that is accessible by the computer system/server 10, including non-transitory, volatile and non-volatile media, removable and non-removable media. The system memory 28 could include one or more computer system readable media in the form of volatile memory, such as a random access memory (RAM) 30 and/or a cache memory 32. By way of example only, a storage system 34 can be provided for reading from and writing to a non-removable, non-volatile magnetic media. The system memory 28 may include at least one program product 40 having a set (e.g., at least one) of program modules 42 that are configured to carry out the functions of embodiments of the subject technology. The program product/utility 40, having a set (at least one) of program modules 42, may be stored in the system memory 28 by way of example, and not limitation, as well as an operating system, one or more application programs, other program modules, and program data. Each of the operating system, one or more application programs, other program modules, and program data or some combination thereof, may include an implementation of a networking environment. The program modules 42 generally carry out the functions and/or methodologies of embodiments of the invention as described herein. For example, the program modules 42 may carry out the steps for recognizing voice issued commands, extract data such as business name from a voice based message, searching a database business directory for matches, and transmitting the voice based message to the contact's device.

The computer system/server 10 may also communicate with one or more external devices 14 such as a keyboard (not shown), a pointing device (not shown), etc. and integrated devices such as a display 24, a microphone (not shown), etc.; and/or any devices (e.g., network card, modem, etc.) that enable the computer system/server 10 to communicate with one or more other computing devices. Such communication can occur via Input/Output (I/O) interfaces 22. Alternatively, the computer system/server 10 can communicate with one or more networks such as a local area network (LAN), a general wide area network (WAN), and/or a public network (e.g., the Internet or a telephonic wireless network) via a network adapter 20. As depicted, the network adapter 20 may communicate with the other components of the computer system/server 10 via the bus 18.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the disclosed technology may take the form of a computer program product embodied in one or more computer readable media having computer readable program code embodied thereon.

Any combination of one or more computer readable media (for example, storage system 34) may be utilized. In the context of this disclosure, a computer readable storage medium may be any tangible or non-transitory medium that can contain, or store a program (for example, the program product 40) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor 16 of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A computer program product for providing a voice activated message to a business, the computer program product comprising a non-transitory computer readable storage medium having computer readable program code embodied therewith, the computer readable program code being configured to, when executed by a processor:
recognize a user's voice activated command and voice based message from a computing device running a software application of the computer program product;
search, via a request made from the computing device through a telecommunications network, an electronic database for a business targeted by the voice based message;
retrieve contact information for the targeted business; and
send contents of the voice based message to a contact matching the contact information through a messaging service.

2. The computer program product of claim 1, further comprising computer readable code configured to:
extract a business name and approximate location from the message;
identify one or more businesses matching the extracted business name and approximate location; and
send the identified one or more businesses to the user.

3. The computer program product of claim 1, further comprising computer readable code configured to convert the voice based message into text sent to the contact matching the contact information.

4. The computer program product of claim 3, further comprising computer readable code configured to send a text based reply from the contact to the user.

5. A method of providing a voice activated message to a business, comprising:
recognizing a user's voice activated command and voice based message from a computing device running a software application of the computer program product;
searching, via a request made from the computing device through a telecommunications network, an electronic database for a business targeted by the voice based message;
retrieving contact information for the targeted business; and
sending contents of the voice based message to a contact matching the contact information through a messaging service.

6. The method of claim 5, further comprising:
extracting a business name and approximate location from the message;
identifying one or more businesses matching the extracted business name and approximate location; and
sending the identified one or more businesses to the user.

7. The method of claim 5, further comprising converting the voice based message into text sent to the contact matching the contact information.

8. The method of claim 6, further comprising sending a text based reply from the contact to the user.
